(19) United States
(12) Patent Application Publication
(10) Pub. No.: US 2009/0100690 A1
(43) Pub. Date: Apr. 23, 2009

(54) Universal saw

(76) Inventors: Stefano Delfini, Bettlach (CH); Hans Kaiser, Leuzigen (CH); Daniel Saegesser, Langenthal (CH); Charles Degutis, Neuhofen (DE)

Correspondence Address: STRIKER, STRIKER & STENBY, 103 East Neck Road, Huntington, NY, 11743, US

(21) Appl. No.: 12/341,360

(22) Filed: Dec. 22, 2008

Related U.S. Application Data
(62) Division of application No. 10/555,480, filed on Nov. 3, 2005.

(30) Foreign Application Priority Data
May 15, 2004 (DE) 10 2004 024 279.1

(51) Int. Cl. B27B 19/00

(52) U.S. Cl. 30/392

(57) ABSTRACT

A hand power tool that can be folded in its longitudinal span, having a housing base body that holds the driven tool insert and whose axis is adjustable—relative to the axis of a housing part serving as a handle—around a folding axis, is made especially compact and lightweight in that the hand power tool is embodied in the form of a universal saw that has the ability to be locked in various angular positions of the housing parts relative to one other; the housing part contains the drive motor, whose driven rotary motion is transmitted via an angle transmission to the tool insert—a saw blade—that is guided in the housing base body.

### CROSS-REFERENCE TO RELATED APPLICATION

This application claims the benefit of priority of U.S. patent application Ser. No. 10/555,480 filed on Nov. 3, 2005 under 35 USC 119(e). The subject matter of the aforesaid U.S. patent application is further explicitly incorporated herein by reference thereto.

The invention described and claimed hereinbelow is also described in German Patent Application DE 10 2004 024 279.1 filed on May 15, 2004. This German Patent Application, whose subject matter is incorporated here by reference, provides the basis for a claim of priority of invention under 35 U.S.C. 119(a)-(d).

### BACKGROUND OF THE INVENTION

The invention is based on a cordless screwdriver There is a known cordless screwdriver, the 3.6 V PSR made by Bosch, which has a convenient rod-like shape. The essentially cylindrical housing can fold at approximately the halfway point of its longitudinal span. The driven tool insert, in this case a screwdriver bit, is held in the front end of a front housing base body. The rear housing part, which serves as a handle, can be folded around a folding axis, which is perpendicular to the longitudinally extending main axis of the cordless screwdriver. This yields a hand power tool that can still be used easily even in very tight spaces. This cordless screwdriver has met all the demands and requirements made of it in terms of the kinds of uses described—but in fact only for handling screwdriving uses.

### SUMMARY OF THE INVENTION

Taking the above-described advantages of the prior art as a point of departure, a universal saw is created that has comparable advantages in terms of where it is used. Beyond this, a universally usable saw is created that is optimally able to handle both sawing as a jigsaw and sawing as a sabre saw. The universal saw embodied according to the invention can be used for both rough work and fine work.

The universal saw can be made especially compact if the angle transmission and a motion converter that converts the driven rotary motion of the drive motor into the axially reciprocating working motion of the saw blade are combined into a transmission unit. To make it possible to use commercially available saw blades, which are adapted to various sawing uses, for sawing as a jigsaw or a sabre saw, it is expedient for the tool insert tappet to have a clamping system that is universally suitable for accommodating various insertion ends of commercially available saw blades, i.e. jigsaw blades with a so-called single-cam shank or sabre saw blades with a so-called universal shank.

In order to achieve an optimum sawing function, it is expedient if the base plate, which is for resting on the work piece to be machined, can be moved from its normal position into various angular positions in which it can be optionally locked.

Other advantageous embodiments ensue from the drawings, the associated description, and the defining characteristics contained in the claims.

### BRIEF DESCRIPTION OF THE DRAWINGS

FIG. 1 shows a universal saw embodied according to the present invention, situated in a 90° angular position of its housing parts, in the form of a straight jigsaw,

FIG. 2 shows the same universal saw in an extended 180° position in the form of a sabre saw,

FIGS. 3 & 4 each show enlarged details of the drive train and the locking of the housing parts of the universal saw according to FIGS. 1 and 2, essentially only in their linkage region,

FIG. 5 shows a partial sectional depiction of a second exemplary embodiment of a universal saw in an extended 180° position in which it is not locked,

FIG. 6 shows a detail of only the locking of the universal saw according to FIG. 5, in a view that is rotated by 90° in relation to FIG. 5, and

FIG. 7 shows a locking element of the exemplary embodiment according to FIG. 5.

### DESCRIPTION OF THE PREFERRED EMBODIMENTS

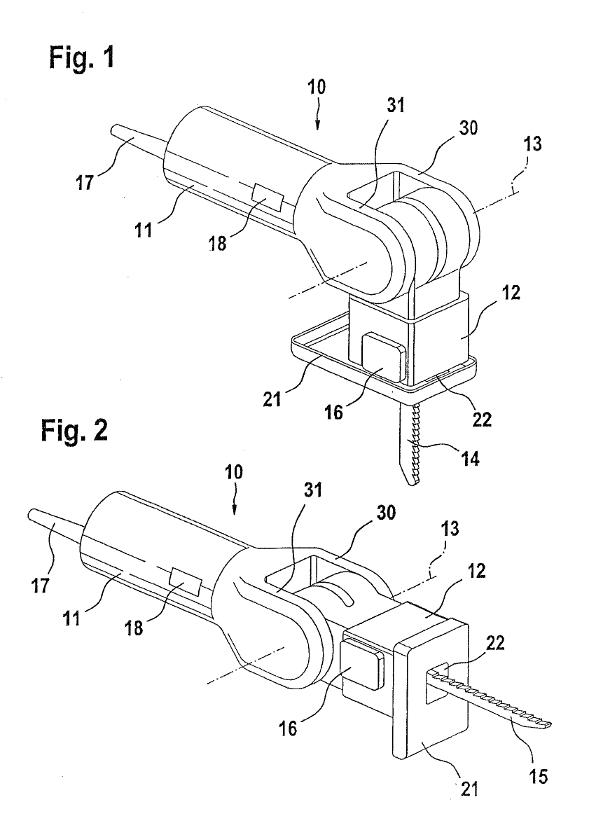

A universal saw 10 shown in FIG. 1 and FIG. 2 has a housing comprised essentially of two housing parts—a housing part 11 and a housing base body 12. The housing part 11 can be adjusted in its angular position around a folding axis 13 in relation to the housing base body 12. FIG. 1 shows the universal saw 10 in a position in which it functions as a straight jigsaw in which the housing part 11 and the housing base body 12 in which a tool insert is guided—in this case a conventional saw blade 14 for jigsaws—are situated at a 90° angle to each other. FIG. 2 shows the same universal saw in an extended 180° position in which it can be used as a sabre saw. In this intended use, a conventional sabre saw blade 15 is used in the housing base body 12.

A clamping system for the saw blades situated inside the housing base body 12 in a manner not shown in the drawing makes it possible to use saw blades 14 or 15 that are adapted to the respective sawing operation—either as a jigsaw for particularly fine work or as a sabre saw for rougher work, the clamping system having the capacity to clamp the special insertion ends of both jigsaw blades 14 and sabre saw blades 15. On the underside of the housing base body 12, which is oriented toward the work piece to be machined and from which the saw blade 14, 15 protrudes, a base plate 21 is situated in an intrinsically known fashion, which extends in an essentially normal orientation in relation to the working movement direction of the saw blade 14, 15 and serves to support the tool on the work piece—not shown here. The base plate 21 has an opening 22 through which the saw blade 14, 15 extends. In order to bring the base plate into the optimum position in relation to the work piece, for example when using the tool as a sabre saw, it can be moved out of its normal position into various angular positions in which it can be optionally locked. An operating lever 16 for operating the clamping system is situated at the free end of the housing base body 12. As is clearly evident from FIGS. 1 and 2, the housing part 11 serves as a handle of the universal saw, which the user operating the hand power tool uses to hold and guide the universal saw. At the same time, the housing part 11 accommodates an electric drive motor for the universal saw, whose power supply cable 17 is situated at the free end of the essentially cylindrical housing part 11.

As mentioned above, the housing parts 11, 12 can be adjusted in terms of their angular position in relation to each other around the folding axis 13, but must be locked in relation to each other in order to assure reliable function. This is executed by means of a locking device—not described until further below—that can be operated by means of an operating knob, which is mounted on the outside of the housing part 11 and in this instance is embodied as a slider 18 that can be moved along a surface line of the cylindrical housing part 11. The slider 18 can be moved out of the locked position counter to the force of a spring, not shown in detail here, thus making it possible to adjust the angular position of the housing parts 11 in relation to each other.

A power switch for the power supply to the drive motor is provided on the side of the housing part 11 not visible in FIGS. 1 and 2.

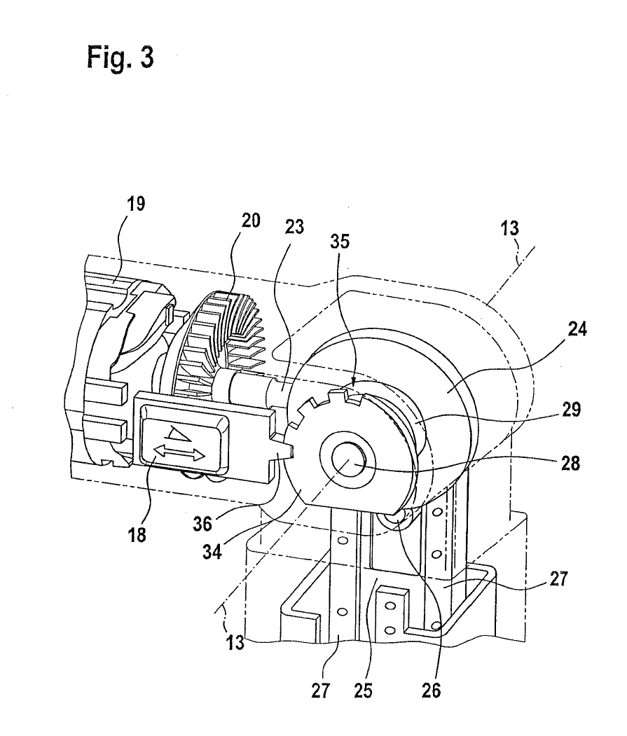

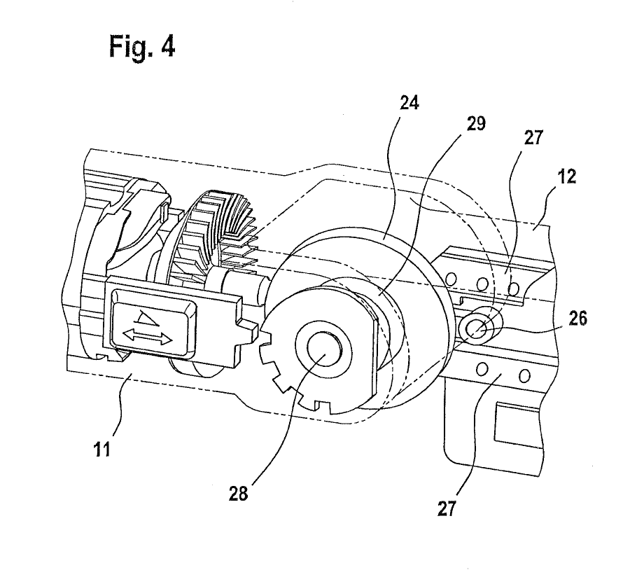

FIGS. 3 and 4 show enlarged depictions of the drive train of the universal saw and the locking of the housing parts 11, 12. For the sake of clarity, the outer contours of the universal saw 10 shown in FIGS. 1 and 2 are depicted with only dashed lines.

FIG. 3 shows the right end part of the electric drive motor 19, which can, for example, be a universal motor. The motor shaft protrudes centrally from the drive motor and supports a fan impeller 20. The free end of the motor shaft supports a driven pinion 23, which meshes with a gear 24. The driven pinion 23 and the gear 24 constitute an angle transmission in the drive train of the universal saw; the axis of the gear 24 is the driven axis of the angle transmission, which coincides with the folding axis 13 of the housing parts 11, 12. This achieves a very compact design that is small, which is very useful in hand power tools.

The side of the gear 24 equipped with the teeth also has the input member of a motion converter that converts the driven motion of the angle transmission 23, 24 and thus of the drive motor 19 into the reciprocating working motion of the saw blade 13, 14. Consequently, the axis of the driven pinion 23 of the drive motor 19 and the axis of the common shaft 28 (folding axis 13) define a plane, yielding a very compact transmission unit.

In this exemplary embodiment, the motion converter is comprised of an intrinsically known connecting rod drive whose input member—the crankshaft, so to speak—is embodied in the form of an eccentric pin on the gear 24. The pin supports a connecting rod 26 whose other free end is connected in articulating fashion to a tool insert tappet 25, which finally supports the saw blade 13, 14—it constitutes the crosshead, so to speak, of the connecting rod drive. The tool insert tappet 25 has a rectangular cross section and is guided in the conventional fashion in sliding guides 27 in the housing base body 12, as depicted in FIG. 3.

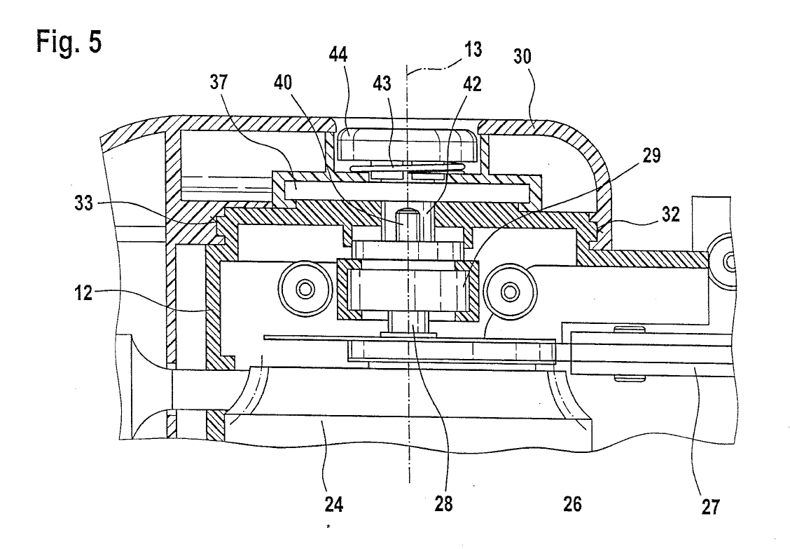

For the sake of clarity, a full depiction of the connecting rod drive has been omitted in FIG. 3 of the drawings because it involves machine elements that are known, particularly in jigsaws and sabre saws. These elements can also be subsequently seen in a different context in FIG. 5.

On the left and right sides, the common shaft 28 is supported by ball bearings; only one of these ball bearings 29 is visible in FIGS. 3, 4, and 5. The ball bearings 29 are respectively secured in associated bearing points in the housing base body, as depicted in FIG. 5.

The housing part 11, which is only depicted with dashed lines in FIGS. 3 and 4, is embodied in the form of a hollow cylinder in the region that contains the drive motor 19 and ends with two diagonally opposing bracket-shaped holding arms 30, 31, the insides of which are provided with slide bearing points 32 in which the corresponding slide bearings on the outsides of the housing base body 12 engage, as shown in FIG. 5, thus constituting the folding support with the folding axis 13.

At the free end of the common shaft 28 toward the front in FIGS. 3 and 4, a rotatable, essentially circular disk 34 is provided as a locking element for locking the housing parts 11, 12 and has a flattened region on one side with which a connection in the housing base body 12 is produced in a manner that is fixed against relative rotation. Along its circumference, the disk 34 has a number of groove-like detent openings 35 that are open toward the edge. Each of these detent openings 35 is associated with a respective preset angular position between the housing part 11 and the housing base body 12 when a detent projection 36 of the respective other locking element engages in the detent opening 35.

This other locking element is the slider 18, which can be moved along a surface line of the cylindrical housing part 11 counter to the force of a clamping spring, not visible in the drawing, which spring holds the slider 18 in its detent locking position. In FIG. 3, this detent locking position is the 90° position and in FIG. 4, it is the 180° position. The drawings do not show intermediate positions that are determined by the type of sawing to be performed with the universal saw—a finer or rougher cut within potentially limited working space.

The function of this first exemplary embodiment of a universal saw is clearly evident. It should merely be noted that the locking of the housing parts 11, 12 is executed by actuating the slider 18, which causes the locking elements to disengage from one another. Once the universal saw has been brought into the desired angular position, the user operating the hand power tool releases the slider 18, causing the detent projection 35 to engage with the detent opening.

FIG. 5 of the drawings, as mentioned previously, depicts an additional exemplary embodiment of a universal saw embodied according to present invention, this time situated in its extended 180° position.

The angle transmission constituted by the driven pinion 23 of the drive motor 18 and the gear 24, the motion converter embodied in the form of a connecting rod drive equipped with the connecting rod 26, which are situated on the common shaft 28, and the support of the common shaft 28 in ball bearings 29 that are secured in the housing base body correspond entirely to the first exemplary embodiment according to FIGS. 3 and 4, which is why the same reference numerals have been used.

In the second exemplary embodiment of a universal saw shown in FIG. 5, a modified locking mechanism has been selected. The one locking element, which produces a form-locking engagement between the housing parts 11, 12, is embodied as an octagonal sheet metal part 37. It is inserted into a recess—which is situated coaxial to the common shaft 28, adapted to the octagonal outer contour, and contained in the housing part 11 containing the drive motor 19—and is thus attached to the housing part 11 in a manner that is secured against relative rotation. The sheet metal part 37 contains detent openings 38 embodied in the form of bores (FIG. 7), which are situated on a graduated circle. Each pair of diagonally opposed bores 38 is associated with an angular position of the housing parts 11, 12 in relation to each other. The sheet metal part 37 is provided with a through bore 39 coaxial to the above-mentioned graduated circle on which the bores 38 are situated.

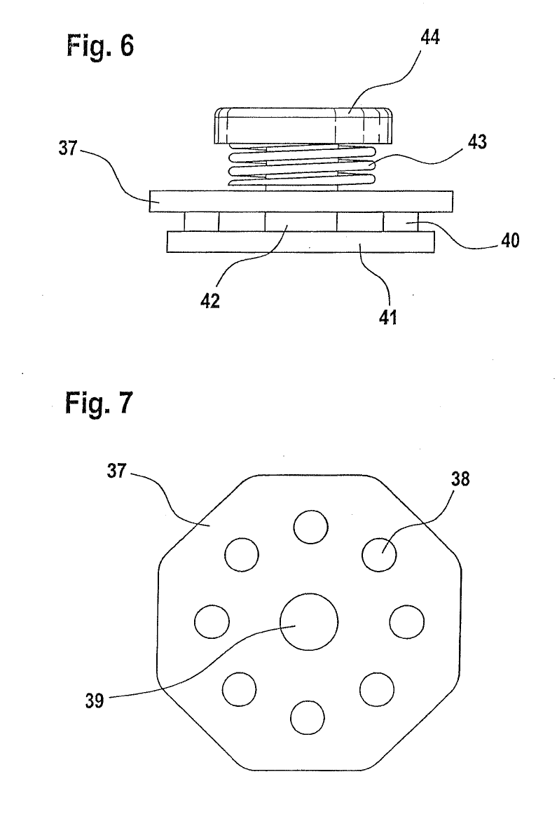

In the detent position, detent projections 40 of the other locking element engage in the detent openings (bores) 38. The detent projections 40 are cylindrical in shape and protrude at right angles from the two end regions of the other locking element embodied in the form of an essentially rectangular sheet metal body 41. In the middle between the detent projections, the sheet metal body 41 has a shaft 42 fastened to it, likewise protruding at right angles. The shaft 42 is supported in the central through bore 39 of the other locking element embodied in the form of the sheet part 37. At the end of the shaft 42 oriented away from the sheet metal body 41 and protruding from the through bore 39 is a coaxial, helical clamping spring 43, which is braced against the sheet metal part 37 at one end and is braced against the inner edge of a push button 44 at the other end. It is clear in FIGS. 5 and 6 that the clamping spring 43 encourages the detent elements to remain engaged (see FIG. 6).

If the user operating the hand power tool presses the push button 44, then this disengages the detent elements counter to the force of the clamping spring 43; in this state shown in FIG. 5, the housing parts 11, 12 are able to move in relation to each other into a different angular position.

In addition to the motion converter that is embodied as a connecting rod drive in both of the exemplary embodiments of the universal saw, there are naturally also other conceivable forms, which, if only the teaching relating to the orientation according to the present invention of the axes of the individual elements is retained, yield a modular transmission design that is very compact because it is comprised of a small number of parts and is correspondingly lightweight. Thus the input member of the motion converter can also be embodied in the form of a curved disk, for example a cam, with which the inner end of the tool insert tappet works in opposition. In this case, the tool insert tappet can be provided with a sliding guide or can be held against the curved disk by means of a spring.

1. A hand power tool (10), which is foldable in its longitudinal span, having a housing base body (12) that holds the driven tool insert (14, 15) and whose axis is adjustable—relative to the axis of a housing part (11) serving as a handle—around a folding axis (13), wherein the hand power tool (10) is embodied as a universal saw that has the ability to be locked in various angular positions of the housing parts (11, 12) relative to one another and the housing part (11) contains the drive motor (19), whose driven rotary motion is transmitted via an angle transmission (23, 24) to the tool insert—a saw blade (13, 14)—that is guided in the housing base body (12).

2. The universal saw as recited in claim 1, wherein the angle transmission (23, 24) and a motion converter that converts the driven rotary motion of the drive motor (19) into the axially reciprocating working motion of the saw blade (13, 14) are combined into a transmission unit.

3. The universal saw as recited in claim 2, wherein the driven pinion (23) of the drive motor (19), meshing with a gear (24), constitutes the angle transmission, and the gear (24) is operatively connected to an input member of the motion converter.

4. The universal saw as recited in claim 3, wherein the gear (24) and the input member of the motion converter are located side by side on a common shaft (28), whose axis is the folding axis (13).

5. The universal saw as recited in claim 4, wherein the input member of the motion converter is embodied as a crankshaft of a connecting rod drive, which works on a tool insert tappet (25) that supports the saw blade (13, 14) and is guided in crosshead fashion in the housing base body (12).

6. The universal saw as recited in claim 4, wherein the input member is embodied as a curved disk, preferably a cam, which cooperates with tool insert tappet (25) that carries the saw blade (14, 15).

7. The universal saw as recited in claim 3, wherein the axis of the driven pinion (23) of the drive motor (19) and the axis (13) of the common shaft (28), extending perpendicular to one another, define a plane.

8. The universal saw as recited in claim 1, wherein the folding axis (13) around which it is possible to fold the housing parts (11, 12) in relation to one another, the output axle of the angle transmission (24), and the axis of the input member of the motion converter all coincide.

9. The universal saw as recited in claim 8, wherein the housing part (11)—at least in the region containing the drive motor (19)—is embodied essentially in the form of a hollow cylinder and ends in two bracket-like, diagonally opposed holding arms (30, 31), on the insides of which slide bearings (32) are situated, which are engaged on the inside by corresponding slide bearings (33) on the outsides of the housing base body (12).

10. The universal saw as recited in claim 9, wherein ball bearings (29) in which the common shaft (28) is guided are situated in the housing base body (12) coaxial to the slide bearings (32, 33).

11. The universal saw as recited in claim 6, wherein the tool insert tappet (25) is connected, guided in compulsory fashion, to the curved disk by means of a cam guide embodied in the manner of a slider.

12. The universal saw as recited in claim 5, wherein the tool insert tappet (25) has a rectangular cross section, which is guided in sliding guides (26) of the housing base body (12).

13. The universal saw as recited in claim 1, wherein the locking of the housing parts (11, 12) in various angular positions is effected by means of locking elements, meshing with one another by form-locking engagement, which are guided on the one hand in the housing part (11) and on the other in the housing base body (12).

14. The universal saw as recited in claim 13, wherein one of the locking elements has detent openings (35, 38) and a clamping spring (43) keeps at least one detent projection (36, 40) of the other locking element in engagement with a respective detent opening (35, 38), it being possible to disengage the latter locking element counter to the force of the clamping spring (43).

15. The universal saw as recited in claim 14, wherein the locking element is embodied as a slider (18), which is movable, parallel to the axis of the driven pinion (23), in the wall of the housing part (11) containing the drive motor (19), and the detent projection (36) of this slider engages in a respective groove-like detent opening (35)—which is open at the edge and associated with one angular position—of the other locking element, which is embodied as a circular disk (34) and which is connected in a manner fixed against relative rotation to the housing base body (12) that guides the saw blade (14, 15).

16. The universal saw as recited in claim 15, wherein the disk (34) connected to the housing base body (12) in a manner fixed against relative rotation is situated on the common shaft (28) of the motion converter.

17. The universal saw as recited in claim 14, wherein the first locking element is embodied as a polygonal, preferably octagonal, sheet metal part (37), which is received in a manner fixed against relative rotation in an adapted recess, situated coaxial to the common shaft (28), of the housing part (11) and has detent openings (38), embodied as bores, respective pairs of which situated diagonally opposite one another on a graduated circle are each associated with one angular position and are engaged by cylindrical detent projections (40) of the second locking element, which is situated in the housing base body (12) in a manner fixed against relative rotation, but is axially disengageable, preferably by means of a push button (44) that is accessible from outside.

18. The universal saw as recited in claim 17, wherein the second locking element is embodied as an essentially rectangular sheet metal body (41) from whose two end regions the two cylindrical detent projections (4) protrude in perpendicular fashion.

19. The universal saw as recited in claim 18, wherein centrally between the detent projections (40), a shaft (42) is secured in a manner fixed against relative rotation, which extends through a central through bore (39) in the first locking element (37) and on which the helical clamping spring (43) is seated coaxially, which spring is braced at one end against the sheet metal part (37) and at the other against the inner edge of the push button (44) secured to the free end of the shaft (42) and keeps the detent projections (40) engaged with the detent openings (38).

20. The universal saw as recited in claim 1, wherein the tool insert tappet carries a clamping system, actuatable by means of an operating lever (16), which is suitable for accommodating various insertion ends of commercially available saw blades (14, 15) of jigsaws and/or sabre saws.

21. The universal saw as recited in claim 1, wherein attached to the housing base body (12) that guides the saw blade (14, 15) is a base plate (21) for resting on the work piece to be machined, which base plate extends in an essentially normal orientation in relation to the working motion direction of the saw blade (14, 15).

22. The universal saw as recited in claim 21, wherein it is possible to move the base plate (21) out of its normal position into various angular positions and to optionally lock it in these positions.
